(19) United States
(12) Patent Application Publication
(10) Pub. No.: US 2026/0326959 A1
(43) Pub. Date: Oct. 22, 2026

(54) METHOD FOR OPERATING A LABELLING APPARATUS

(71) Applicant: Espera-Werke GmbH, Duisburg (DE)

(72) Inventors: Thorsten ZERFASS, Mülheim an der Ruhr (DE); Alexander SCHULZ, Mülheim an der Ruhr (DE)

(21) Appl. No.: 18/881,008

(22) PCT Filed: Jun. 23, 2023
(86) PCT No.: PCT/EP2023/067155

§ 371 Date: Jan. 3, 2025

(30) Foreign Application Priority Data
Jul. 6, 2022 (DE) 10 2022 116 896.4

(51) Int. Cl. B65C 1/02

(52) U.S. Cl. CPC B65C 1/021

(57) ABSTRACT

A method for operating a labeling apparatus for labeling packages that includes, as functional units, weighing, dispensing and printer assemblies. The functional units are driven by an operation control in a labeling routine according to a control specification and operating parameters. An operator interface is used to accept control commands from an operator. The labeling routine is carried out by means of the operation control on the basis of the control commands. An evaluation assembly uses a sensor to determine at least one operating state value of the functional units, to monitor the at least one operating state value and/or the accepted control commands for satisfaction of a predefined variance criterion, to respond to satisfaction of the variance criterion by performing a notification routine that prompts a handling recommendation output to the operator via the operator interface that includes at least one operator action aimed at altering the labeling routine.

### BACKGROUND OF INVENTION

### Field of Invention

The present invention relates to a method for operating a labeling apparatus, an evaluation assembly for operating a labeling apparatus, and a labeling apparatus for carrying out the method.

### Brief Description of Related Art

The labeling apparatus under discussion here is designed for labeling individual packages and in particular as a pricing apparatus. The labeling apparatus comprises at least one weighing assembly, a dispensing assembly and a printer assembly as functional units, which are configured for labeling the individual packages in a labeling routine. An operation control of the labeling apparatus perceives the control tasks associated with carrying out the labeling routine and drives the functional units to label the individual packages in accordance with a control specification.

Such a labeling apparatus and a method for operating the labeling apparatus are described for example in DE 10 2019 132 710 A1.

To ensure reliable and accurate labeling, there is provision for a sensor assembly for determining operating state values, which are monitored by means of an evaluation assembly in the labeling routine. If, for example, there is a variance between an operating state value and an expected value, the operator is made aware of this in a notification routine by way of a warning. The variance can be traced back, in general terms, to the operating state of the labeling apparatus, to external influences or to an operating error by the operator.

One challenge in this scenario is that although the operator is made aware of an existing problem by way of notification in the form of a warning, the complexity of the labeling apparatus means that it may be unclear how the state can be rectified. In particular, it may not be readily apparent which of the functional units is the source of the variance in the operating state value, whether external influences are responsible for the variance or whether there has been an operating error.

The problem on which the invention is based is that of designing and developing the known method in such a way that operator friendliness is increased further.

### BRIEF SUMMARY OF THE INVENTION

The above problem is solved by the inventions disclosed herein.

An essential aspect is the fundamental consideration that the operator often does not always know the optimum approach owing to a possible lack of clarity about a cause of error and the wealth of available handling options.

In particular, it is proposed that the evaluation assembly is used in the notification routine to prompt a handling recommendation to be output to the operator via the operator interface, and that the handling recommendation includes at least one operator action, to be performed by the operator, that is aimed at altering the labeling routine.

In the particularly preferred arrangement, the operator action included in the handling recommendation is aimed at rectifying the state that leads to satisfaction of the variance criterion. This ensures that the handling recommendation communicated to the operator is used to optimize the operating state or rectify a malfunction.

The operator action included in the handling recommendation relates to the changing of an operating parameter. This allows optimization of the operation to be implemented by the operator in a particularly simple manner. The operating parameter that is changed can preferably relate to the conveying speed of a feed assembly, the orientation of the conveyed packages and the driving of the printer assembly and/or of an applicator assembly for the labels.

Moreover, the consideration of humidity values is particularly preferred, this allowing in particular a current cleaning operation to be identified.

Besides the use of sensor data, the evaluation assembly in the arrangement may be configured to check accepted control commands on the basis of an operating error criterion. This achieves particularly easily implemented protection against an operating error. The operating error criterion is preferably defined according to the operating state value, and so the control commands are checked for a possible operating error according to the respective operating situation.

In the further preferred embodiments, the evaluation assembly, in the notification routine, monitors satisfaction of a termination criterion. This can involve the operator being asked to confirm receipt of the handling recommendation by means of the operator interface. The termination criterion may be defined by way of the operator not acknowledging receipt of the handling recommendation in a predefined period or not implementing the operator actions.

The operator interface may be in a wide variety of forms and in particular in the form of a mobile device. In the preferred arrangement, the operator interface comprises a portable visual output unit and is configured to visually display the action, to be performed by the operator, that is described in the handling recommendation.

Particularly preferably, there is provision for a camera system that is used to capture objects and in particular components of the labeling apparatus and to display a recommended interaction with the objects. This greatly simplifies the implementation of the handling recommendation for the operator, in particular in the case of very complex handling recommendations having multiple handling steps. The output unit may be in the form of smartglasses.

Based on to a further teaching, which has independent significance, an evaluation assembly for operating a labeling apparatus is claimed.

An essential aspect in this case is that the evaluation assembly, in the notification routine, prompts a handling recommendation to be output to the operator via the operator interface, and that the handling recommendation includes at least one operator action, to be performed by the operator, that is aimed at altering the labeling routine. Reference may be made to all the embodiments of the proposed method.

Based on a further teaching, which also has independent significance, a labeling apparatus for carrying out the proposed method is claimed. Reference may be made to all the embodiments of the proposed method and the proposed evaluation assembly.

### BRIEF DESCRIPTION OF THE DRAWINGS

The invention is explained in more detail below with reference to drawings that merely illustrate exemplary embodiments. In the drawings:

FIG. 1 shows a schematic representation of the labeling system with a control assembly and an operator interface for carrying out the method, and

FIG. 2 shows a schematic diagram for the method.

### DETAILED DESCRIPTION OF THE INVENTION

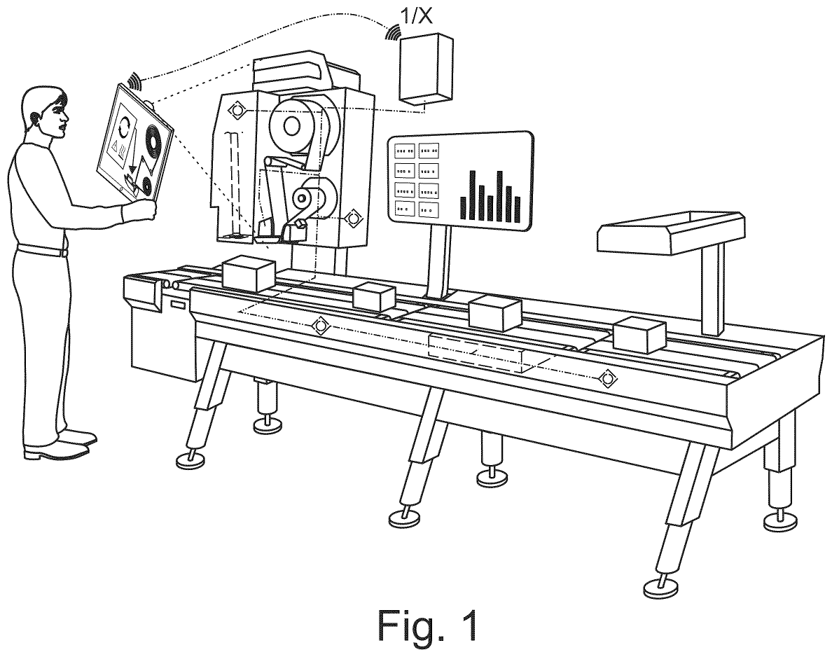

The invention relates to a method for operating a labeling apparatus 1 for labeling individual packages 2. FIG. 1 shows the labeling apparatus 1, which is in particular in the form of a pricing apparatus, in a schematic representation.

The labeling apparatus 1 comprises, as functional units, at least one weighing assembly 3 for determining a weight value of the package 2, a dispensing assembly 4 for dispensing a label from a material strip 5 and a printer assembly 6 for printing the label.

In an arrangement that is not shown, the labeling apparatus 1 is intended for partially manual labeling of the packages 2. For example, the package 2 is manually placed onto the weighing assembly 3, a label printed by the printer assembly 6 being dispensed by means of the dispensing assembly 4. The label is also manually applied to the package 2, for example.

The weighing assembly 3 is used to determine weight values of the packages 2. The weighing assembly 3 comprises a weighing cell that determines analog and/or digital weight values representative of the weight of the package 2. The weight values are determined in particular on the basis of a deformation measurement from a support for the package 2, for instance using strain gauges, and/or on the basis of electromagnetic force compensation for the weight force of the respective package 2.

The dispensing assembly 4 is intended to dispense the label, which may be designed to be detachable from a material strip 5. A label detachable from a material strip 5 means in particular a label that has its adhesive surface detachably mounted on a carrier strip that forms the material strip 5 and, for example, may be based on paper and/or plastic. It is also possible for the label to be produced by removing a subsection from a printable or printed material strip 5, for instance by cutting and/or tearing the material strip 5. In particular, labels in the form of adhesive labels are used, which already have an adhesive surface by means of which they are detachably affixed to the material strip 5. Similarly, it is also conceivable to use adhesive-free labels that are not provided with an adhesive surface or applied to an adhesive surface on the respective package 2 until later.

The printer assembly 6 is intended to print the label, the label being able, in principle, to be printed on the material strip 5 and/or after the label has been removed from the material strip 5 and also before, after or while the label is applied to the respective package 2. Here and preferably, there is provision for a printer assembly 6 configured for thermal printing, in particular direct thermal printing or heat transfer printing.

Besides said functional units, there may also be provision for further functional units, which are also shown in FIG. 1 and which will be discussed below. Similarly, the labeling apparatus 1 may be a part of a labeling system having multiple labeling apparatuses 1.

The labeling apparatus 1 comprises an operation control 7. In a labeling routine, the functional units are driven to label the individual packages 2 by means of the operation control 7 in accordance with a control specification and on the basis of operating parameters. To this end, the operation control 7 preferably comprises control electronics for implementing the control tasks arising during the labeling routine. As is also shown in a simplified fashion in FIG. 1, the operation control 7 may be a central operation control 7 of the labeling apparatus 1 that drives all or at least some of the functional units. It is also possible for the operation control 7 to comprise multiple decentralized control units that communicate with one another, each functional unit preferably having a respective associated control unit. The operation control 7 may also be implemented by way of a control system that is external to the functional units, for example an external computer system.

At least part of the labeling routine is determined by operating parameters. Here and preferably, an operating parameter is a setting that is predetermined manually or by the operation control 7 and determines the sequence of the labeling routine. The operating parameters firstly comprise control parameters of the functional units in accordance with the control specification, for example the printing speed of the printer assembly 6 or weighing parameters of the weighing assembly 3. Secondly, the operating parameters can also be understood to be states relating to the labeling routine, such as the orientation of the packages 2 or the size of the labels. The control specification should be understood in general terms to mean a rule that relates to the way in which the labeling apparatus 1 operates and that also reproduces the dependency on the at least one operating parameter.

The labeling apparatus 1 comprises an operator interface 8 that is configured for the interchange of data between the operator 9 and the operation control 7. The operator interface 8 is used to accept control commands from the operator 9. Here and preferably, the operator interface 8 comprises a touchscreen 10. Further components of the operator interface 8, such as a warning lamp, a loudspeaker or the like, are also conceivable. The operator interface 8 is used here to communicate information about the labeling apparatus 1, in particular the selected operating parameters and the measured operating state values, to the operator 9. Here and preferably, control commands should be understood to mean instructions relating to the control specification that are in particular geared to triggering, changing or ending the labeling routine. This can be done for example by stipulating or adjusting an operating parameter. The control commands are input in the operator interface 8 by the operator 9 and then relayed from the operator interface 8 to the operation control 7, which performs the labeling routine on the basis of the control commands.

There is also provision for an evaluation assembly 11 of the labeling apparatus 1, the evaluation assembly 11 monitoring the operation of the labeling apparatus 1. The labeling apparatus 1 comprises a sensor assembly 12 that is used to determine operating values attributed to the functional units. Here, the term sensor assembly 12 combines sensor units associated with the functional units. The sensor data determined by the respective sensor units are in particular processed and relayed as operating values to the operation control 7 and are used in particular for monitoring and driving the functional units in the labeling routine.

The operating values are also determined by means of the evaluation assembly 11. The evaluation assembly 11 can also receive the control commands. As shown in FIG. 1, the evaluation assembly 11 may be, by way of example, a server for the labeling apparatus 1, which server is superordinate to the operation control 7 and performs an evaluation of the operating values that is described below. Here, the evaluation assembly 11 is connected to the operation control 7 and/or to the sensor assembly 12 via a local communication network. However, it is also possible for the operation control 7 to be a component of the evaluation assembly 11.

Here and preferably, there is furthermore provision for the evaluation assembly 11 to be connected to a cloud 13 that comprises at least one cloud server 14. It is conceivable for at least some of the tasks arising on the evaluation assembly 11 to be perceived by means of the cloud server 14. In the arrangement shown, however, the operating values are evaluated locally on the labeling apparatus 1, for example.

The evaluation assembly 11 is used to monitor the at least one operating state value and/or the accepted control commands for satisfaction of a predefined variance criterion. The monitoring can be carried out continuously or discontinuously at predefined time intervals. The variance criterion in this case is representative of the circumstance that the further operation of the labeling apparatus 1 is impaired, will probably be impaired and/or that the current operation of the labeling apparatus 1 is inconsistent with expected, optimum operational management. An impairment in this case may be any rectifiable impairment of the operation of the labeling apparatus 1, for example a jam in the dispensing assembly 4 or an inadmissible temperature at one of the functional units. By way of example, the operation of the labeling apparatus 1 is not optimum when the actual throughput of packages 2 per unit time is below a specified value, when the print quality is inconsistent with a further specified value and/or when a significant share of the labels is applied incorrectly. In general terms, the notification routine can involve any form of message to the operator 9 by means of the operator interface 8, for example output of a warning tone or a visual display on the touchscreen 10.

An essential aspect is now that the evaluation assembly 11 is used in the notification routine to prompt a handling recommendation to be output to the operator 9 via the operator interface 8, and that the handling recommendation includes at least one operator action, to be performed by the operator 9, that is aimed at altering the labeling routine.

The handling recommendation is an instruction to the operator 9 to behave in a particular manner relevant to the labeling routine. The handling recommendation can be communicated by way of a text-based and/or graphical description, in particular as a video or animation, and/or audibly. An operator action is understood to mean any directed physical interaction between the operator 9 and their surroundings. An operator action can also be understood to mean the conscious omission of an interaction.

Here, the operator action included in the handling recommendation is aimed at adjusting the labeling routine. This can be done in a wide variety of ways, for example by adjusting the operating parameters, but also by adjusting the labeling apparatus 1 and in particular the functional units, for example by means of a maintenance operation, replacement of a wear component and/or refiling of a consumable, for example labels. The operator action may also be aimed at interacting with the immediate surroundings of the labeling apparatus 1, for example with other objects in the room in which the labeling apparatus 1 is operated.

The handling recommendation can include qualitative and quantitative information relating to the operator action. Preferably, the handling recommendation includes multiple operator actions and in particular a recommended order of operator actions. It is also conceivable for the handling recommendation to include a suggestion for multiple, alternative operator actions, which are in particular also provided with a weighting.

Preferably, there is provision for the operator action included in the handling recommendation to be aimed at canceling satisfaction of the variance criterion. Consequently, the handling recommendation may be aimed at resolving the situation, or the circumstances, that have led to satisfaction of the variance criterion when the operator action is performed by the operator 9. As already mentioned, there may be, for example, less than optimum operation of the labeling apparatus 1, or else a fault state, that is at least moderated when the operator actions included in the handling recommendation are performed.

In this case, the evaluation assembly 11 can resort to an evaluation specification that includes, for example, various such situations and circumstances and the reproduction thereof in the operating state values. The evaluation specification can include measures that are the basis for the recommended operator actions and that trace back in particular to experiences with the operation of labeling apparatuses 1. For example, when a fault state occurs, an experienced operator 9 is able, after the fault state has been manually resolved, to store the operator actions to be performed in the respective situation in the evaluation assembly 11. If such a fault state occurs again, a less experienced operator 9 can be instructed on the basis of the handling recommendation.

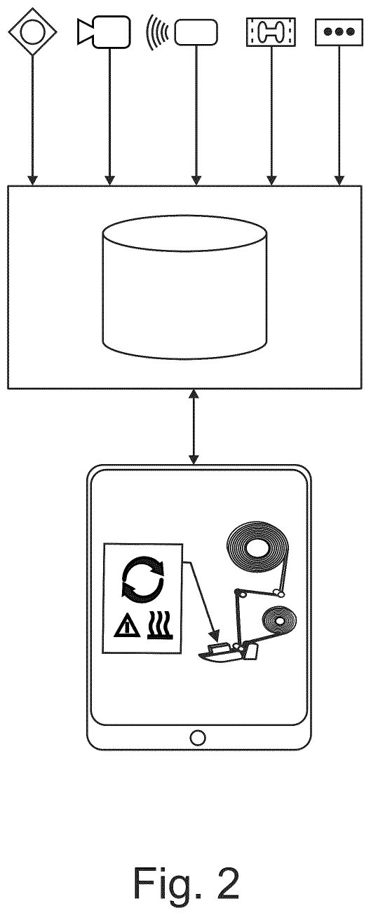

FIG. 2 shows a schematic diagram for the proposed method. The operating state values are determined by means of the evaluation assembly 11 on the basis of the sensor assembly 12, which, here and preferably, comprises various sensor types. The evaluation assembly 11 here is configured to accept and process sensor data. Similarly, the sensor data can be processed in the sensor assembly 12 and/or in the operation control 7, and operating state values can be forwarded to the evaluation assembly 11. Examples of sensor types are optical, acoustic and/or mechanical sensors, in particular cameras 15, temperature sensors 16, proximity sensors 17, mechanical stress sensors 18, moisture sensors 19, or the like. The available operating state values are monitored for satisfaction of a special situation by means of the evaluation assembly 11 on the basis of the variance criterion. Satisfaction of the variance criterion is in turn responded to by taking the operating state values, in particular the evaluation specification, as a basis for generating the handling recommendation.

Furthermore, here and preferably, there is provision for the operator action included in the handling recommendation to relate to the changing of at least one operating parameter.

By way of example, the operator 9 is advised that a specific operating parameter that can be input by the operator 9 via the touchscreen 10, for example, needs to be altered. Preferably, the operating parameter may also be an operating parameter that is not directly influenceable by means of the operation control 7. For example, the operator 9 is advised that manual adjustment of one of the functional units and/or packages 2, or of a further apparatus related to the labeling apparatus 1, for example a supply apparatus for the packages 2, is recommended.

In a simple arrangement, the handling recommendation can direct the operator 9 to which operating parameter needs to be adjusted, the actual quantitative adjustment—for example optimization of a numerical value—being performed by the operator 9 themselves. Additionally, however, the operator 9 can also be provided with a quantitative indication of the operating parameter (for example that the operating parameter needs to be increased/reduced, that an optimum value range and/or an optimum value is proposed, or the like). The operator 9 can also be offered a suggestion for the adjustment of an operating parameter, which the operator 9 is merely meant to confirm or reject.

As already mentioned, the handling recommendation can be based, for example on the basis of the evaluation specification, on specific situations that are known to be causes of a fault or of less than optimum operation.

In the arrangement that is shown, and in this respect preferred, the labeling apparatus 1 comprises a feed assembly 20 for conveying the packages 2. The feed assembly 20 is preferably a belt conveyor or a roller conveyor, possibly also at least one robot arm, for moving the respective packages 2. Here and preferably, the feed assembly 20, here the belt conveyor, comprises at least one conveyor belt 21 that is used to convey the respective packages 2 along a conveying direction.

Preferably, the weighing assembly 3 is in the form of a dynamic weighing assembly 3 that determines the weight values of moving packages 2 and thus permits continuous operation of the labeling apparatus 1. In FIG. 1, the weighing assembly 3 is accordingly provided on the feed assembly 20. Similarly, the printer assembly 6 and/or an additional printer assembly 22 may be provided on the feed assembly 20 and for example can print the moving package 2, in particular the label applied to the package 2.

The operating parameter to be changed can relate to the conveying speed of the feed assembly 20. For example, the recommended operator action can suggest increasing the conveying speed if the operating state values indicate that the workload of the functional units is low. If the workload is too high, which is recognizable from the operating state values and becomes clear as a result of increased temperature and/or incorrect labeling operations, for example, the recommended operator action may include reducing the conveying speed. Furthermore, an excessively high feed rate can be recognized on the basis of weight values from the weighing assembly 3, which can lead for example to mechanical vibrations and/or to overlap between weight values of adjacent packages 2.

The weight values can also be taken as a basis for recognizing other causes of failures. For example, ambient conditions, for instance as a result of a draft or vibrations, can lead to vibrations that are transferred to the weighing assembly 3. If, for example based on the operating state values, the vibrations cannot be attributed to the labeling apparatus 1 itself, which is tested in particular on the basis of a correlation between the time dependency of the weight values and at least one further operating state value, the handling recommendation can direct the operator 9 to adjusting the ambient conditions.

Similarly, the operator action can relate to the alteration of the spatial alignment of the packages 2. A cause of incorrect labeling operations in this scenario may be inaccurate alignment of the packages 2 relative to the feed assembly 20 or incorrect supply (diagonally rather than lengthways or the like). By way of example, the operator action may then be aimed at adjusting the feed rate of an alignment assembly (not shown here) for the packages 2 and/or of a supply apparatus for the packages 2.

In a further arrangement, there is provision for the operating parameter that is to be changed to relate to the driving of the printer assembly 6.

If a printed image is incorrect, the operator 9 is directed to suitable measures for adjusting the operation of the printer assembly 6. By way of example, the operator action may be aimed at shifting the print template in such a way, or of using an alternative print template, that incorrect dots of the thermal print head of the printer assembly 6 are no longer used or are used to a lesser extent.

In the arrangement that is shown, and in this respect preferred, the labeling apparatus 1 comprises an applicator assembly 23 for applying the label to the respective package 2, the operating parameter to be changed relating to the driving of the applicator assembly 23. The applicator assembly 23 may be provided as a further functional unit in a common housing with the dispenser assembly 4. Preferably, the dispensed label is picked up by a punch 24, which, here and preferably, is in the form of an oscillating punch, and applied to the respective package 2. In particular, the punch 24 comprises a blow head 25 for aspirating and releasing the label. During application, the oscillating punch here moves along the conveying direction in order to permit the package 2 moved by means of the feed assembly 20 to be labeled. The applicator assembly 23 can be used to apply the label through contact by pressing the label onto the package 2. Additionally or alternatively, it is conceivable for the label to be applied in a contactless fashion, for example by virtue of the blow head 25 of the punch 24 blowing the label onto the package 2 by producing a blast of compressed air directed toward the package 2.

The variance criterion can relate to incorrect application of the labels, for example inadequate fixing, an incorrect orientation and/or position of the applied labels and an absence of labeling of packages 2, and/or collisions between the applicator assembly 23, in particular the punch 24, and packages 2. The operating parameter to be changed can relate for example to the movement of the punch 24, in particular the speed of the punch 24, the height of the blow head 25 relative to the feed assembly 20, the trigger time for the movement of the punch 24, the pressure used by the blow head 25 for the blast of compressed air, or the like.

Here and preferably, there is provision for the sensor assembly 12 to comprise at least one moisture sensor 19 and for the variance criterion to relate to humidity values determined using the moisture sensor 19. By way of example, an increased humidity can trace back to a manual cleaning operation that is incomplete. By way of example, the handling recommendation can communicate to the operator 9 that a housing of a specific functional assembly needs to be opened and/or dried before operation is continued. Similarly, an inadmissible cleaning operation, for example, during the operation of the labeling apparatus 1 can be detected by means of the moisture sensor 19, and corresponding advice can be output to the operator 9 that cleaning must stop.

Furthermore, here and preferably, there is provision for the variance criterion to include an operating error criterion that relates to the accepted control commands. For example, an accepted control command is contrary to an optimization of operation determined by means of the evaluation unit or can lead to operation of the labeling apparatus 1 that is accompanied by increased wear or even damage to the labeling apparatus 1. Preferably, the operating error criterion is defined according to the at least one operating state value, and so the operator 9 is advised of possible incorrect operation according to the present situation. The operator 9 can also be advised that with the respectively input control command it is advisable to adjust further operating parameters and in particular to input further control commands for optimum operation.

Preferably, there is provision for the operator 9 to be asked during the notification routine to make an operator input on the operator interface 8, preferably for the operator 9 to use the operator input to confirm acknowledgement of the handling recommendation. The confirmation can be provided for example by operating a button on the operator interface 8 or by way of audible feedback, for instance by uttering a confirmation.

Furthermore, here and preferably, there is provision for satisfaction of a termination criterion to be monitored in the notification routine and for the evaluation assembly 11 to be used to respond to satisfaction of the termination criterion by carrying out an emergency routine, preferably for the emergency routine to comprise an alteration to the labeling routine that is automatically made by means of the evaluation assembly 11, more preferably for the alteration of the labeling routine to comprise interruption of the driving of at least one of the functional units by the evaluation assembly 11.

Accordingly, an automatic reaction can be provided by means of the evaluation assembly 11, in particular when the operator 9 does not react or reacts incorrectly to the situation that leads to satisfaction of the variance criterion. By way of example, the evaluation assembly 11 can alter operating parameters by communicating with the operation control 7. The termination criterion is in particular representative of there being a threat of damage to the labeling apparatus 1, damage to packages 2 and/or risk to the operator 9.

Furthermore, here and preferably, there is provision for at least part of the termination criterion to be defined by way of the operator input being absent within a predefined time interval, and/or for at least part of the termination criterion to be defined by way of at least one operator action included in the handling recommendation being absent within a predefined optimization time interval.

The optimization time interval may be a variable that is definable by the operator 9 in advance. The optimization time interval can alternatively be defined by the evaluation assembly 11, in particular according to the operating state values.

Furthermore, here and preferably, there is provision for the operator interface 8 to comprise a mobile visual output unit 26, and for the output unit 26 to be used to visually display the operator action included in the handling recommendation.

A mobile visual output unit 26 in this case is an electronic device that has at least one visual display unit for information, for example a display. The mobile visual output unit 26 in this case may be directly or indirectly connected to the evaluation unit by means of a wireless communication connection. The operator action can be displayed either statically or by movement, for example in an animation.

Furthermore, here and preferably, there is provision for the output unit 26 to comprise a camera unit for capturing image data, the output unit 26 being configured to visually display an interaction with at least one object captured in the image data, in particular a component of the labeling apparatus 1, which interaction is included in the handling recommendation as an operator action, preferably for the output unit 26 to be in the form of smartglasses.

Preferably, the output unit 26 is used to visually highlight surroundings objects. Here and preferably, however, the surroundings objects mean the components belonging to the labeling apparatus 1, in particular the functional units of the labeling apparatus 1. The processing of the image data that this requires can be carried out by means of a data processing system, for instance a microprocessor, associated with the mobile visual output unit 26. It is alternatively possible for the image data to be sent to the evaluation assembly 11 and processed thereby. The image data can be processed in a wide variety of ways in this case, for example using heuristics or a machine learning model, in particular a convolutional neural network or another machine learning model attributable to deep learning. The output unit 26 can be used to provide augmented reality, here to assist the operator 9 in performing the handling recommendation.

The interaction in this case can include any physical effect on the surroundings object, in particular on the functional units of the labeling apparatus 1. As such, it is conceivable for the output unit 26 to represent the opening of a closure element of the applicator assembly 23 or the removal of a foreign body.

Smartglasses here are a portable computer that adds information to the field of vision of the operator 9. To this end, the smartglasses have a, in particular transparent, display onto which the information in question is projected. This can be accomplished for example by means of a spherical mirror or using a waveguide.

An evaluation assembly 11 for operating a labeling apparatus 1 for labeling, in particular pricing, individual packages 2 is also proposed, the labeling apparatus 1 comprising, as functional units, at least one weighing assembly 3, a dispensing assembly 4 and a printer assembly 6, the functional units being driven by an operation control 7 of the labeling apparatus 1 in a labeling routine in accordance with a control specification and on the basis of operating parameters of the functional units, the labeling apparatus 1 comprising an operator interface 8 that is used to accept control commands from an operator 9, and the labeling routine being carried out by means of the operation control 7 on the basis of the control commands, the evaluation assembly 11 using a sensor device associated with the labeling apparatus 1 to determine at least one operating state value of the functional units, and the evaluation assembly 11 monitoring the at least one operating state value and/or the accepted control commands for satisfaction of a predefined variance criterion, and responding to satisfaction of the variance criterion by prompting a notification routine.

Furthermore, here and preferably, there is provision for the evaluation assembly 11, in the notification routine, to prompt a handling recommendation to be output to the operator 9 via the operator interface 8, and for the handling recommendation to include at least one operator action, to be performed by the operator 9, that is aimed at altering the labeling routine.

Reference may be made to all the embodiments of the proposed method.

Preferably, the evaluation assembly 11 is also configured to drive the functional units to label the individual packages 2 in a labeling routine. In this respect, the evaluation assembly 11 can include the operation control 7 already described.

A labeling apparatus 1 for carrying out the proposed method is proposed. Reference may be made to all the embodiments of the proposed method and the proposed evaluation assembly 11.

Moreover, further subject matter disclosed, which has independent significance, is a computer program product comprising commands that, when executed on a computer of an evaluation assembly 11 of a labeling system, cause the evaluation assembly 11 to carry out the proposed method.

The computer program product is preferably stored in an electronic memory. Particularly preferably, the evaluation assembly 11 comprises a memory that is used to store the commands of the computer program product, and at least one processor for executing the program instructions, the memory and the commands being configured to drive the labeling system to carry out the proposed method together with the processor.

The memory preferably comprises a nonvolatile memory for the program instructions, for example a flash memory, an EEPROM memory, a magnetic memory and/or an optical memory. The memory may furthermore be equipped with a main memory, preferably a random access memory (RAM) or the like. The processor preferably comprises a microprocessor, a digital signal processor and/or an application-specific integrated circuit.

1-13. (canceled)

14: A method for operating a labeling apparatus for labeling individual packages said labeling apparatus including, as functional units, at least one weighing assembly, a dispensing assembly and a printer assembly, said functional units being configured to be driven by an operation control of the labeling apparatus in a labeling routine in accordance with a control specification and on the basis of operating parameters of the functional units, said labeling apparatus including an operator interface configured to accept control commands from an operator, and said labeling routine being configured to be carried out by means of the operation control on the basis of the control commands, wherein:
an evaluation assembly is employed to use a sensor device associated with the labeling apparatus to determine at least one operating state value of the functional units;
the evaluation assembly is used to monitor the at least one operating state value and/or the accepted control commands for satisfaction of a predefined variance criterion, and to respond to satisfaction of the variance criterion by performing a notification routine;
the evaluation assembly is used in the notification routine to prompt a handling recommendation to be output to the operator via the operator interface; and
the handling recommendation includes at least one operator action, to be performed by the operator, that is aimed at altering the labeling routine.

15: The method as claimed in claim 14, wherein the operator action included in the handling recommendation is aimed at canceling satisfaction of the variance criterion.

16: The method as claimed in claim 14, wherein the operator action included in the handling recommendation relates to the changing of at least one operating parameter and/or wherein the operator action relates to the alteration of the spatial alignment of the packages.

17: The method according to claim 16, wherein the labeling apparatus comprises a feed assembly for conveying the packages and wherein the operating parameter to be changed relates to the conveying speed of the feed assembly.

18: The method as claimed in claim 16, wherein the operating parameter to be changed relates to the driving of the printer assembly and/or wherein the labeling apparatus comprises an applicator assembly for applying the label to a respective one of the individual packages and wherein the operating parameter to be changed relates to the driving of the applicator assembly.

19: The method as claimed in claim 14, wherein the sensor assembly comprises at least one moisture sensor and wherein the variance criterion relates to humidity values determined using the moisture sensor.

20: The method as claimed in claim 14, wherein the variance criterion includes an operating error criterion that relates to the accepted control commands.

21: The method as claimed in claim 20, wherein the operating error criterion is defined according to the at least one operating state value.

22: The method as claimed in claim 14, wherein the operator is asked during the notification routine to make an operator input on the operator interface.

23: The method as claimed in claim 22, wherein the operator uses the operator input to confirm acknowledgement of the handling recommendation.

24: The method as claimed in claim 14, wherein satisfaction of a termination criterion is monitored in the notification routine and wherein the evaluation assembly is used to respond to satisfaction of the termination criterion by carrying out an emergency routine.

25: The method as claimed in claim 24, wherein the emergency routine comprises an alteration to the labeling routine that is automatically made by means of the evaluation assembly.

26: The method as claimed in claim 25, wherein the alteration of the labeling routine comprises interruption of the driving of at least one of the functional units by the evaluation assembly.

27: The method as claimed in claim 14, wherein at least part of the termination criterion is defined by way of the operator input being absent within a predefined time interval, and/or wherein at least part of the termination criterion is defined by way of at least one operator action included in the handling recommendation being absent within a predefined optimization time interval.

28: The method as claimed in claim 14, wherein the operator interface comprises a mobile visual output unit, and wherein the output unit is used to visually display the operator action included in the handling recommendation.

29: The method as claimed in claim 14, wherein the output unit comprises a camera unit for capturing image data, the output unit being configured to visually display an interaction with at least one object captured in the image data, said at least one object being a component of the labeling apparatus, which interaction is included in the handling recommendation as an operator action.

30: The method as claimed in claim 29, wherein the output unit is in the form of smartglasses.

31: An evaluation assembly for operating a labeling apparatus for labeling individual packages, said labeling apparatus including, as functional units, at least one weighing assembly, a dispensing assembly and a printer assembly, said functional units being configured to be driven by an operation control of the labeling apparatus in a labeling routine in accordance with a control specification and on the basis of operating parameters of the functional units, the labeling apparatus including an operator interface configured to accept control commands from an operator, and said labeling routine being configured to be carried out by means of the operation control on the basis of the control commands, wherein:
the evaluation assembly is configured to use a sensor device associated with the labeling apparatus to determine at least one operating state value of the functional units;
the evaluation assembly is configured to monitor the at least one operating state value and/or the accepted control commands for satisfaction of a predefined variance criterion, and to respond to satisfaction of the variance criterion by prompting a notification routine;
the evaluation assembly is configured, in the notification routine, to prompt a handling recommendation to be output to the operator via the operator interface; and
the handling recommendation includes at least one operator action, to be performed by the operator, that is aimed at altering the labeling routine.

32: A labeling apparatus for carrying out a method as claimed in claim 14.
